(19) United States
(12) Patent Application Publication
(10) Pub. No.: US 2010/0027371 A1
(43) Pub. Date: Feb. 4, 2010

(54) Closed Blending System

(76) Inventors: Bruce Lucas, Marlow, OK (US); Stanley Stephenson, Duncan, OK (US); Calvin Stegemoeller, Duncan, OK (US); Herb Horinek, Duncan, OK (US); Glenn Weightman, Duncan, OK (US)

Correspondence Address: JOHN W. WUSTENBERG, P.O. BOX 1431, DUNCAN, OK, 73536, US

(21) Appl. No.: 12/182,297

(22) Filed: Jul. 30, 2008

(51) Int. Cl. B01F 15/02

(52) U.S. Cl. 366/134

(57) ABSTRACT

Methods and systems for blending a dry material with a fluid in a closed environment are disclosed. A liquid component is supplied from a liquid delivery system to a mixing chamber. A dry component or a high solid content slurry is then supplied from a dry material tank or an external proppant storage to the mixing chamber. The dry component or high solid content slurry is then mixed with the liquid component in a closed system to prepare a desired mixture.

### BACKGROUND

The present invention relates generally to methods and systems for blending materials and more particularly, to methods and systems for blending a dry material with a fluid in a closed environment.

Oil field operations often involve the blending of dry materials with a fluid. For instance, dry materials may be added to a fracturing fluid in blending equipment or to a cementing fluid in cement equipment. Additionally, acidizing and preparation of oil field drilling mud or other chemicals often involves blending dry materials with a fluid.

Traditionally, oil field applications utilize a variety of positive displacement or other fluid delivery pumps to introduce the fluid into an open tub. Once the fluid is in the open tub, the dry material is moved into the tub using an auger and is mixed with the fluid. The mixture is then pumped downhole for any of a variety of applications such as acidizing or fracturing the formation.

The traditional methods of mixing dry materials with fluids have several disadvantages. The mixing tub is often open, exposing the mixture to the environment and compromising the mixture quality. Moreover, the open tub may pose a health risk to the personnel who are exposed to chemicals and there is a risk that the mixture will spill, introducing potentially hazardous materials into the surrounding environment. In addition, the traditional methods generally require numerous pieces of equipment and multiple operators to ensure the proper operations of the system.

Another drawback of conventional methods is the need for equipment to control the level of material in the tub to ensure there is no overflow. Further, control of the level of the tub is a necessary step in providing closed-loop control of the proportioning of liquid chemicals, dry chemicals, and other dry materials. Finally, with customary methods, the metering of the dry materials being added is inexact, generally allowing for only intermittent readings.

### FIGURES

Some specific example embodiments of the disclosure may be understood by referring, in part, to the following description and the accompanying drawings.

FIG. 1 is a schematic block diagram of a closed blending system in accordance with an embodiment of the present invention.

FIG. 2 is a schematic block diagram of a closed blending system in accordance with another embodiment of the present invention.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention relates generally to methods and systems for blending materials and more particularly, to methods and systems for blending a dry material with a fluid in a closed environment.

In one embodiment, the present invention is directed to a closed blending system comprising: a liquid delivery system for delivering liquid material; a tank for containing dry material; a feeder inlet coupled to the tank; a feeder device coupled to the feeder inlet; a mixing chamber comprising a first inlet, a second inlet and an outlet; wherein the first inlet is coupled to the feeder device; and wherein the second inlet is coupled to the liquid delivery system.

In another embodiment, the present invention is directed to a method of blending a mixture comprising: supplying a liquid component from a liquid delivery system to a mixing chamber; supplying a dry component from a dry material tank to a feeder inlet; lubricating the dry component; feeding the dry component from the feeder inlet to the mixing chamber; and mixing the dry component and the liquid component to form a mixture within the mixing chamber.

In yet another embodiment, the present invention is directed to a closed blending system comprising: an external proppant storage for storing a high solid content slurry; a feeder device coupled to the external proppants storage; a liquid delivery system; a mixing chamber having a first inlet, a second inlet and an outlet, wherein the first inlet is coupled to the feeder device; and wherein the second inlet is coupled to the liquid delivery system.

The features and advantages of the present disclosure will be readily apparent to those skilled in the art upon a reading of the description of exemplary embodiments, which follows.

### DESCRIPTION

The present invention relates generally to methods and systems for blending materials and more particularly, to methods and systems for blending a dry material with a fluid in a closed environment.

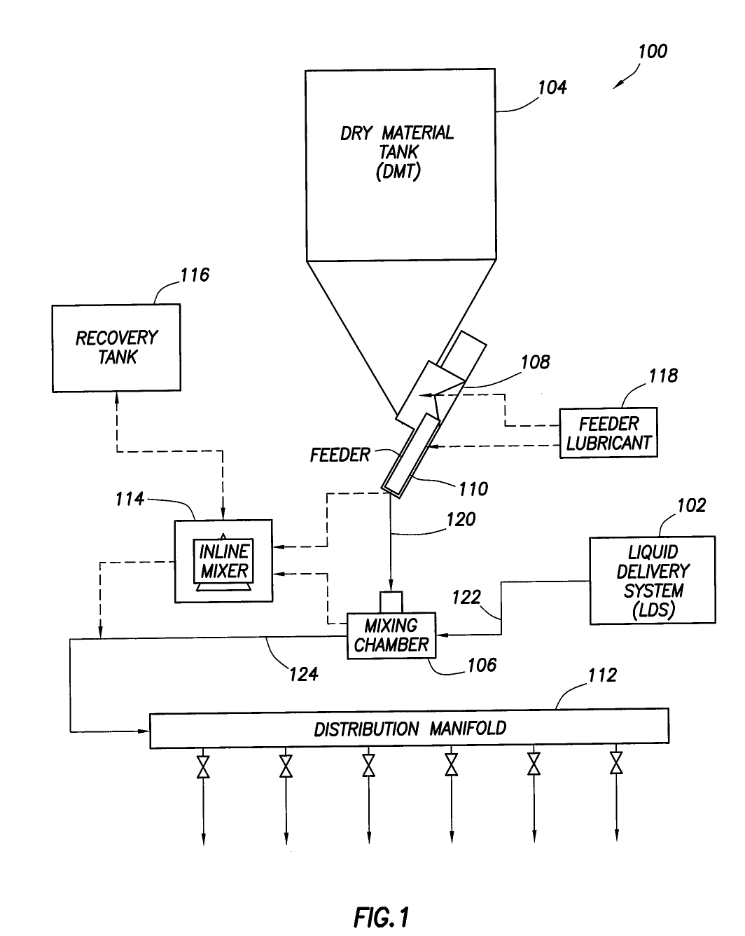

FIG. 1 depicts a closed blending system 100 in accordance with an embodiment of the present invention. The closed blending system 100 includes a Liquid Delivery System (“LDS”) 102 and a Dry Material Tank (“DMT”) 104. The LDS 102 may be used to deliver any of a number of different liquids, including, but not limited to, water, a frac fluid, liquid components of an Acid mixture, a Frac Fluid mixture, a Hydro-jetting mixture, a cement mixture, and a drilling fluid mixture, depending on the particular application. In one exemplary embodiment, the LDS 102 may be the discharge from a dry gel mixer which provides a mixture of dry gelling agent and base fluid (typically water) and/or the discharge from a system providing a mixture of chemical additives (which may include liquid chemicals, dispersed solid chemicals, suspended solid chemicals, and dissolved solid chemicals) and base fluid. In another exemplary embodiment, the LDS 102 may be the discharge from an acid batch mixer, the water and liquid additives for a cement slurry, or the liquid portion of a drilling mud. The LDS 102 may meter and deliver the liquid component of the mixture to a mixing chamber 106. As would be appreciated by those of ordinary skill in the art, with the benefit of this disclosure, the LDS 102 may itself include a number of components including, but not limited to, tanks, pumps, piping and control systems as may be desired to combine and deliver a liquid component to the mixing chamber 106. Similarly, the DMT 104 may contain a number of different dry materials, including, but not limited to, a proppant, sand, a dry powdered gel, dry powdered chemicals, cement, clay, a dry drilling fluid component, salt and dry acid stabilizers depending on the particular application.

In one exemplary embodiment, the DMT 104 may be attached to a feeder inlet 108. The feeder inlet 108 collects dry material for distribution by the feeder. In one embodiment, a feeder device 110 may be attached to the feeder inlet 108. The feeder device 110 may meter and inject material from the DMT 104 to the mixing chamber 106. The feeder device 110 may be a modified progressive cavity pump, modified rotary vane pump, modified gear pump or any other device capable of delivering dry material to the mixing chamber 106 and preventing liquids from flowing into the feeder inlet 108. In one embodiment, the feeder device 110 may include an agitator or other mechanisms to reduce bridging of solid materials. In other exemplary embodiments, the feeder device 110 may have lubricant or treatment ports for adding fluids to the material from the DMT 104 in order to lubricate the feeder and/or treat the material from the DMT 104 prior to or during metering. Although one feeder device 110 is depicted in FIG. 1, several feeder devices may be arranged in series, parallel, or a combination thereof prior to a distribution manifold 112 or an inline mixer 114 in order to increase capacity, add various components, and/or create specific dry material distributions. As would be appreciated by those of ordinary skill in the art, with the benefit of this disclosure, each DMT 104 may include load cells that may enable metering by weight loss for rate measurement and inventory management. Further, the delivery of the feeder device 110 may be determined with a solids flow meter or inferred by measuring the motion of the feeder and applying a calibration factor.

In one exemplary embodiment, a feeder lubricant apparatus 118 may be coupled to the feeder inlet 108 and/or the feeder device 110. Two components are deemed “coupled” to one another when they are linked to each other in any manner so as to allow the flow of materials between the components. In one embodiment, the feeder lubricant apparatus 118 may be a progressive cavity pump or any other device suitable for providing a lubricant to feeder device 110. In this embodiment, lubrication may be accomplished by adding lubricating fluid through ports in a progressive cavity portion of the feeder device 110 or by adding lubricating fluid at the feeder inlet 108. In another embodiment, lubrication may be achieved by using dry materials with self lubricating properties or by fabricating the feeder device 110 from materials with self lubricating properties. The lubricating fluid may be one of the liquids available in the LDS 102. Alternatively, the lubricating fluid may be a mineral oil, a vegetable oil, a polymer, or any other lubricating fluid suitable for reducing frictional wear caused by startup and/or enabling the metering of highly abrasive fluids into a pressurized system. The lubricating process may also be used to treat or coat the dry materials prior to introduction to the process stream in particle conditioning strategies.

In one embodiment, the mixing chamber 106 may be a section of pipe or tee located on the feeder device 110 that receives the material from the DMT 104 through a first inlet 120. The mixing chamber also receives a fluid stream from a previous chamber (not shown) or in the case of a first mixing chamber, from the LDS 102, through a second inlet 122. The mixing chamber 106 may allow material from the DMT 104 to be added to a fluid in an environmentally sealed manner, i.e., not exposed to the outside environment, and may decrease the static pressure of the fluid system. The mixing chamber 106 may not be ventilated, allowing the material from the DMT 104 to mix with fluid component(s) of the mixture. That mixture of the material from the DMT 104 and the fluid component(s) may then be discharged to the distribution manifold 112 through an outlet 124. In one embodiment the mixture may be transferred from the mixing chamber 106 to another mixing chamber before being discharged to the distribution manifold 112. In another embodiment, a pump (not shown) may be used to deliver the mixture from the mixing chamber 106 to the distribution manifold 112.

In one exemplary embodiment, the mixture exiting from the mixing chamber 106 is first discharged to an inline mixer 114. In one embodiment, the inline mixer 114 may be a centrifuge. The inline mixer 114 may be installed directly after the feeder device 110 in place of the mixing tee or after the mixing chamber 106 in order to remove entrained air and disperse and/or mix the fluid mixture before it is delivered to the distribution manifold 112. In one embodiment, the inline mixer 114 may be a through flow centrifugal pump or a specialized inline centrifuge that separates air from the fluid by centrifugal force and mechanically mixes the materials. However, any mixing device that imparts adequate energy to cause homogeneous mixture and separation of gaseous components may be used for the inline mixer 114. During this process, denser portions of the fluid, including solids and liquids may be forced through the inline mixer 114 while lighter portions, such as entrained air and gaseous portion, may be removed. The mixture may then be directed to the distribution manifold 112 after passing through the inline mixer 114. In one embodiment, a pump (not shown) is used to transfer the mixture from the inline mixer 114 to the distribution manifold 112.

As the inline mixer 114 allows air to escape through centrifugal suspension, it may allow fluid to escape in the event of a system upset. In one exemplary embodiment, the inline mixer 114 may be reversibly coupled to a recovery tank 116 allowing material to go from the inline mixer 114 to the recovery tank 116 or from the recovery tank 116 to the inline mixer 114, depending on the process performed. The recovery tank 116 may be attached to a center outlet of the inline mixer 114 to collect and contain fluids ejected during an upset. These discharged fluids may then be disposed or, if appropriate, pulled back into the fluid stream with the inline mixer 114.

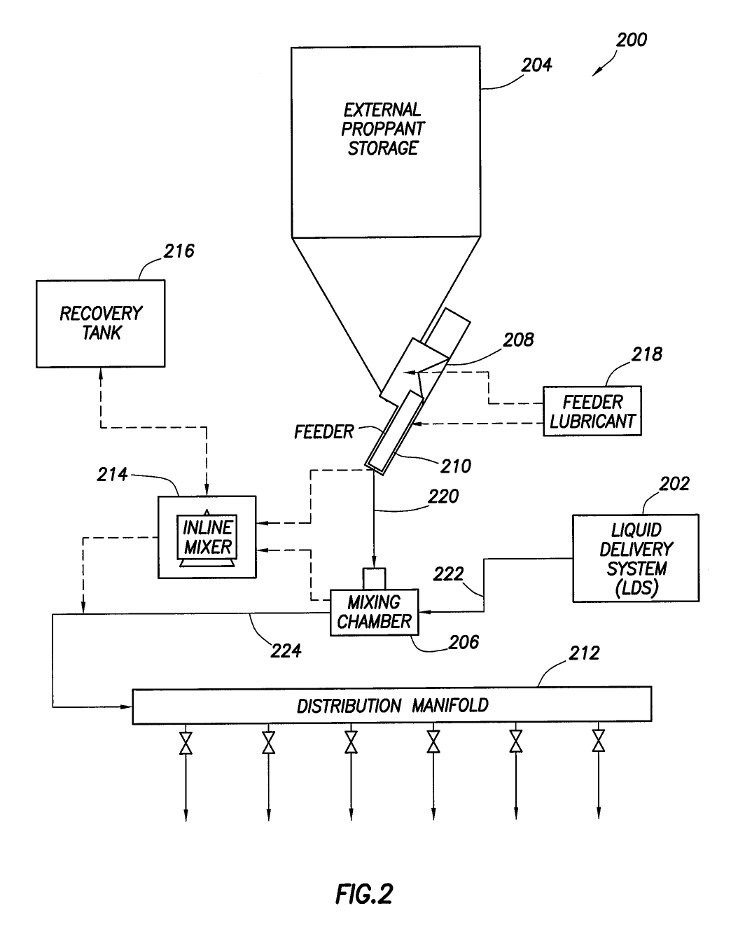

FIG. 2 depicts a closed blending system 200 in accordance with a second embodiment of the present invention. In this embodiment, the DMT 104 is replaced with an External Proppant Storage (“EPS”) 204. The EPS 204 may contain a high solid content slurry such as a “Liquid Sand™” or “Liquid Prop”, available from Halliburton Energy Services, Inc. of Duncan, Okla. A method of forming the Liquid Sand/Liquid Prop is disclosed in U.S. Pat. No. 5,799,734 issued to Norman et al. and assigned to Halliburton Energy Services, Inc. of Duncan, Okla.

In this embodiment, the dry material may be in effect pre-lubricated, reducing the need for addition of lubricants to feeder device 210. The Liquid Sand or Liquid Prop may be passed through the feeder inlet 208 and introduced into mixing chamber 206 by the feeder device 210.

In one exemplary embodiment, the EPS 204 may be attached to a feeder inlet 208. In one embodiment, a feeder device 210 may be attached at the bottom of the feeder inlet 208. The feeder device 210 may be a modified progressive cavity pump or any other device suitable for delivering material from the EPS 204 to the mixing chamber 206 and/or preventing liquids from flowing into the feeder inlet 208. The feeder device 210 may meter and inject the dry portion of the fluid mixture from the EPS 204 into the mixing chamber 206. In one embodiment, the feeder device 210 may include an agitator or other mechanism to reduce bridging. Although one feeder device 210 is depicted in FIG. 2, several feeder devices may be arranged in series, in parallel, or a combination thereof, prior to distribution manifold 212 or inline mixer 214 so as to provide for increased capacity, ability to add various components and/or ability to create specific material distributions. As would be appreciated by those of ordinary skill in the art, with the benefit of this disclosure, any or all EPS 204 may include load cells to enable metering by weight loss for rate measurement and inventory management.

In one exemplary embodiment, a feeder lubricant apparatus 218 may be coupled to the feeder inlet 208 and/or the feeder device 210. In one embodiment, the feeder lubricant apparatus 218 may be a progressive cavity pump or any other device suitable for providing a lubricant to feeder device 210. In this embodiment, additional lubrication may be accomplished by adding lubricating fluid through ports in a progressive cavity portion of the feeder device 210 or by adding lubricating fluid at the feeder inlet 208. In another embodiment, additional lubrication may be achieved by using dry materials with self lubricating properties or by fabricating the feeder device 210 from materials with self lubricating properties. The lubricating fluid may be one of the liquids available in the LDS 202. Alternatively, the lubricating fluid may be a mineral oil, a vegetable oil, a polymer, or any other lubricating fluid suitable for reducing frictional wear caused by startup and/or enabling the metering of highly abrasive fluids into a pressurized system. The lubricating process may also be used to treat or coat the dry materials prior to introduction to the process stream in particle conditioning strategies.

In one embodiment, the mixing chamber 206 may be a section of pipe or tee located on the feeder device 210 to receive material from the EPS 204 through a first inlet 220. The mixing chamber also receives a fluid stream from a previous chamber (not shown) or in the case of a first mixing chamber, from the LDS 202, through a second inlet 222. The mixing chamber 206 allows material from the EPS 204 to be added to fluid(s) in an environmentally sealed manner and may decrease the static pressure of the fluid system. The mixing chamber 206 may not be ventilated and may allow material from the EPS 204 to mix with fluid(s). That mixture of the material from the EPS 204 and fluid(s) may then be discharged to the distribution manifold 212 through an outlet 224. In one embodiment the mixture may be transferred from the mixing chamber 206 to another mixing chamber (not shown) before being discharged to the distribution manifold 212. In another embodiment, a pump (not shown) may be used to deliver the mixture from the mixing chamber 206 to the distribution manifold 212.

In one exemplary embodiment, the mixture from the mixing chamber 206 may first be discharged to the inline mixer 214. In one embodiment, the inline mixer 214 may be a centrifuge. The inline mixer 214 may be installed directly after the feeder device 210 or after the mixing chamber 206 in order to remove entrained air and disperse and/or mix the fluid mixture before it is delivered to the distribution manifold 212. In one embodiment, the inline mixer 214 may be a through flow centrifugal pump or a specialized inline centrifuge that separates air from the fluid by centrifugal force and mechanically mixes the materials. During this process, denser portions of the fluid, including solids and liquids may be forced to an outer surface of the inline mixer 214 by centrifugal force while lighter portions, such as entrained air and gaseous portion, may be forced toward the center of the inline mixer 214. A vent at the center of the mixer may allow the lighter portions to vent to the atmosphere. The mixture may then be directed to the distribution manifold 212 after passing through the inline mixer 214. In one embodiment, a pump (not shown) is used to transfer the mixture from the inline mixer 214 to the distribution manifold 212.

As the inline mixer 214 allows air to escape through centrifugal suspension, it may allow fluid to escape in the event of a system upset. In one exemplary embodiment, the inline mixer 214 may be reversibly coupled to a recovery tank 216 allowing material to go from the inline mixer 214 to the recovery tank 216 or from the recovery tank 216 to the inline mixer 214, depending on the process performed. The recovery tank 216 may be attached to a center outlet from the inline mixer 214 so as to allow collection and containment of fluids ejected during an upset. These discharged fluids may then be disposed or, if appropriate, pulled back into the fluid stream with the inline mixer 214.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In addition, the terms in the claims have their plain, ordinary meaning unless otherwise explicitly and clearly defined by the patentee.

What is claimed is:

1. A closed blending system comprising:
a liquid delivery system for delivering liquid material;
a tank for containing dry material;
a feeder inlet coupled to the tank;
a feeder device coupled to the feeder inlet;
a mixing chamber comprising a first inlet, a second inlet and an outlet;
wherein the first inlet is coupled to the feeder device; and
wherein the second inlet is coupled to the liquid delivery system.

2. The closed blending system of claim 1, further comprising a feeder lubricant apparatus coupled to the feeder device.

3. The closed blending system of claim 2, wherein the feeder lubricant apparatus supplies a lubricating fluid.

4. The closed blending system of claim 3, wherein the lubricating fluid is selected from the group consisting of a mineral oil, a vegetable oil, or a polymer.

5. The closed blending system of claim 1, further comprising a feeder lubricant apparatus coupled to the feeder inlet.

6. The closed blending system of claim 1, wherein the liquid material is selected from the group consisting of water, a frac fluid, a liquid component of an Acid mixture, a Frac Fluid mixture, a Hydro-jetting mixture, a cement mixture, and a drilling fluid mixture.

7. The closed blending system of claim 1, wherein the dry material tank contains a dry material selected from the group consisting of a proppant, sand, a dry powdered gel, dry powdered chemicals, cement, clay, dry drilling fluid components, salt and dry acid stabilizers.

8. The closed blending system of claim 1, wherein the outlet of the mixing chamber is coupled to one of a distribution manifold or a pump.

9. The closed blending system of claim 1, wherein the outlet of the mixing chamber is coupled to an inline mixer.

10. The closed blending system of claim 9, wherein the inline mixer is coupled to a distribution manifold.

11. The closed blending system of claim 10, wherein the inline mixer is reversibly coupled to a recovery tank.

12. The closed blending system of claim 1, wherein the feeder device is selected from the group consisting of a progressive cavity pump, modified rotary vane pump and a modified gear pump.

13. A method of blending a mixture comprising:
supplying a liquid component from a liquid delivery system to a mixing chamber;
supplying a dry component from a dry material tank to a feeder inlet;
lubricating the dry component;
feeding the dry component from the feeder inlet to the mixing chamber; and
mixing the dry component and the liquid component to form a mixture within the mixing chamber.

14. The method of claim 13, further comprising delivering the mixture from the mixing chamber to one of a distribution manifold, a second mixing chamber, or a pump.

15. The method of claim 13, further comprising delivering the mixture from the mixing chamber to an inline mixer.

16. The method of claim 15, further comprising delivering the mixture from the inline mixer to one of a distribution manifold or a pump.

17. The method of claim 15, further comprising reversibly coupling the inline mixer to a recovery tank.

18. A closed blending system comprising:
an external proppant storage,
wherein the external proppant storage stores a high solid content slurry;
a feeder device coupled to the external proppant storage;
a liquid delivery system;
a mixing chamber having a first inlet, a second inlet and an outlet,
wherein the first inlet is coupled to the feeder device; and
wherein the second inlet is coupled to the liquid delivery system.

19. The closed blending system of claim 18, wherein the external proppant storage is configured to store a high solid content slurry selected from the group consisting of a Liquid Sand™ and a Liquid Prop.

20. The closed blending system of claim 18, wherein the outlet of the mixing chamber is coupled to one of a distribution manifold, an inline mixer or a pump.

21. The closed blending system of claim 20, wherein the inline mixer is reversibly coupled to a recovery tank.
